(19) United States
(12) Patent Application Publication
(10) Pub. No.: US 2008/0172679 A1
(43) Pub. Date: Jul. 17, 2008

(54) Managing Client-Server Requests/Responses for Failover Memory Managment in High-Availability Systems

(76) Inventors: Jinmei Shen, Rochester, MN (US); Hao Wang, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/622,302

(22) Filed: Jan. 11, 2007

(51) Int. Cl. G06F 13/14; G06F 15/16

(52) U.S. Cl. 719/318; 709/203

(57) ABSTRACT

A system, method and computer-readable medium for managing service request exception conditions in a computer system that services client requests. In one embodiment, an original client request is received by a server. The client request and responses to the request are generated using fuzzy logic selection from a request/response object pool. A fuzzy logic module is utilized for selecting the request object by correlating the original client request with multiple pre-stored request objects. In response to an exception condition occurring incident to processing the client request, an exception response object is generated containing the original client request and further including an exception object identifying the exception condition. In the case of a retry exception condition, the exception response object includes the client request and a RetryException object. In the case of a forward exception condition, the exception response includes the client request, a ForwardException object, and routing data.

### BACKGROUND OF THE INVENTION

1. Technical Field

The present invention relates generally to service request handling that facilitates efficient memory management in high availability client-server systems. In particular, the present invention relates to a method and system for utilizing a centrally accessible object pool in conjunction with exception condition objects to handle service requests in a manner reducing or eliminating memory leak that might otherwise occur incident to high-availability server failover.

2. Description of the Related Art

Client-server is a network architecture that separates requester or master side (i.e. client side) functionality from a service or slave side (i.e. server side functionality). A client application often includes a graphical user interface, such as provided by a web browser, which enables a user to enter service requests to be sent to and processed by a server application. Specific types of servers include web-page servers, file servers, terminal servers, and mail servers.

Client-server systems requiring highly reliable uninterrupted operability may be implemented as so-called high availability systems. High availability (HA) is a system design protocol and associated implementation that ensures a desired level of operational continuity during a certain measurement period. Such systems often utilize HA clusters to improve the availability of services from the server side. Generally, HA cluster implementations build logical and hardware redundancy, including multiple network connections and complex, multi-connected data storage networks, into a cluster to eliminate single points of failure. The key feature of HA clusters is to utilize redundant computers or nodes to maintain service when system components fail. Absent such redundancy, when a server running a particular application fails, the application may be unavailable until the failed server is fixed and brought back online. HA clustering addresses server node failure by autonomically starting the failing node application on another system in response to detected hardware/software faults. For example, high availability cluster redundancy can be achieved by detecting node or daemon failures and reconfiguring the system appropriately, so that the workload can be assumed by standby or backup cluster nodes. High availability clustering is essential for many modern organizations and institutions, especially those involved in industries having strict compliance and regulatory requirements.

The process of reconfiguring HA cluster servers responsive to a failure is known as a failover condition and may require the clustering software to appropriately configure the backup node before starting the application. For example, appropriate file systems may need to be imported and mounted, network hardware may need to be configured, and some supporting applications may need to be running as well.

In addition to an actual server failure, HA systems are susceptible to memory management problems arising from “soft” failures such as an unsuccessful request processing attempt caused by lack of present server capacity or an incompatible service role of a given server to handle a given request. For example, in a database cluster or object cache cluster, one server is typically configured as a master data server and the other servers are configured as replicas. In such a configuration, data updates are typically handled only by the master data server to maintain data integrity. Requests requiring read-only processing can be processed by either the master data server or replicas. However, if a request requiring an update or write operation is sent to a replica server, the request must be forwarded to the master data server.

Soft failures such as those caused by server overload or incompatible configuration arise more frequently than hard server failures and are difficult to directly manage or prevent due to extremely high traffic volumes and the sometimes shifting configurations and roles of clustered servers. For example, when a server is overloaded (i.e., has received more requests than it can presently process), the excess requests may proceed to a failure sequence or may be stored and retried at later time. Another alternative in the case of either server overload or incompatible server configuration is to forward the presently non-serviceable requests to peer servers having sufficient available capacity.

Request forwarding, retrying, or failures may result in memory management problems as uncleaned and/or non-deallocated request objects and associated objects may consume excessive memory resources, leaving servers to fail or operate at subpar levels. E-business and e-commercial server applications handle millions of transactions per hour, with each transaction comprising an associated request object, response object, and associated other objects. Responsive to hard and/or soft failures often requiring the request to be retried and/or forwarded, each request may traverse and be cached by multiple servers before a successful transaction response is achieved. Under such circumstances, memory leak may cause excessive memory consumption. Ideally, HA servers should maintain steady and stable memory usage over an extended period of time such as years. However, most servers cannot do so in reality and almost all enterprises schedule shutdown and re-start intervals to clean memory at regular intervals.

An important aspect of high availability systems relates to handling of client-server requests and responses, particularly for requests and responses interrupted by a hard or soft failure. Client-server requests/responses are substantial data units, carrying both instructions and data and may be reused in a high availability client-server system. Any given request/response may be reused by different clients or the original requesting client in different stages of client-server interactions to increase both client and server side performance. A given request may not be successfully processed by the original receiving server and may therefore need to be retried at the same server or forwarded to other servers for handling. Such request retries and forwarding results in cached request/response data across possibly multiple nodes which becomes a significant source of memory consumption given that typical servers receive requests at a rate of millions per hour.

A particularly problematic circumstance arises when hard or soft a failure occurs on a server having a large number of cached request/response data items. Under such circumstances, memory leak is likely to occur when the failure protocol requires the original requesting clients to resubmit the requests that were originally sent to the failed server. For reasons of operating efficiency during normal (i.e. non-failover) runtime conditions, memory management mechanisms do not adequately track memory that has been allocated to stalled service requests (i.e. requests required to be retried or forwarded) and which are subsequently misallocated due to a failover and client re-sending of the original request. The likelihood of memory leak is particularly high under circumstances that interfere with standard memory management such as when routing tables change or the server malfunctions. The substantial amount of memory allocated to the cached request/responses is often not automatically reallocated, resulting in substantial memory degradation of the server as well as client nodes in a HA system over time.

It can therefore be appreciated that a need exists for a method, system, and computer program product for managing client request handled by HA server systems in a manner that minimizes memory leak. The present invention addresses this and other needs unresolved by the prior art.

### SUMMARY OF THE INVENTION

A system, method and computer-readable medium for managing service request exception conditions in a computer system that services client requests are disclosed herein. In one embodiment, an original client request is received by a server. The client request and responses to the request are generated using fuzzy logic selection from a request/response object pool. A fuzzy logic module is utilized for selecting the request object by correlating the original client request with multiple pre-stored request objects. In response to an exception condition occurring incident to processing the client request, an exception response object is generated containing the original client request and further including an exception object identifying the exception condition. In the case of a retry exception condition, the exception response object includes the client request and a RetryException object. In the case of a forward exception condition, the exception response includes the client request, a ForwardException object, and routing data.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram illustrating a high availability system adapted to control memory leak incident to high availability server failover in accordance with the invention;

FIG. 2 is a block diagram depicting a data processing system that may be implemented as a server in accordance with a preferred embodiment of the present invention;

FIG. 3 is a block diagram illustrating a data processing system in which the present invention may be implemented;

FIG. 4A is a high-level block diagram depicting a client/server request handling chain that handles requests in a high availability system in accordance with the invention;

FIG. 4B is a high-level block diagram illustrating client-side request handling components in accordance with the present invention;

FIG. 4C is a high-level block diagram depicting server-side request handling components in accordance with the present invention;

FIG. 5A is a block diagram illustrating a forward response object in accordance with the present invention;

FIG. 5B is a block diagram depicting a retry response object in accordance with the present invention;

FIG. 6 is a high-level block diagram illustrating a request object manager and object pool as implemented within an object controller in accordance with one embodiment of the present invention;

FIG. 7 is a high-level flow diagram depicting steps performed during client-side service request management in accordance with one embodiment of the present invention; and

FIG. 8 is a high-level flow diagram depicting steps performed during server-side service request management in accordance with one embodiment of the present invention.

### DETAILED DESCRIPTION OF ILLUSTRATIVE EMBODIMENT(S)

The present invention is directed to memory management relating to failover in high availability client-server systems which may lead to substantial memory leak. More specifically, the present invention is directed to addressing memory leak issues arising when client requests may be retried or forwarded prior to or during failover in a high availability system. The present invention employs an object pool for generating request/response objects. The present invention employs exception condition responses for individually managing failure conditions occurring incident to request/response processing.

The invention depicted and described in further detail below, preferably includes an object pool that advantageously provides fuzzy logic correlation and in-flight modification features that help reduce the required storage capacity for the request/response objects in the object pool. In particular, the object pool does not utilize exact key matching but instead uses fuzzy logic to match and retrieve a closest object and modify the object in-flight to accommodate the original request.

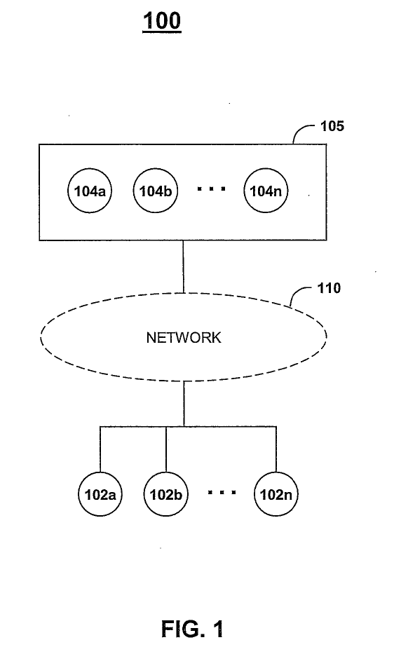

With reference now to the figures wherein like reference numerals refer to like and corresponding parts throughout, and in particular with reference to FIG. 1, there is depicted a high-level representation of a high availability system 100 adapted to control memory leak incident to high availability server failover or other service request interruption such as changing routing table data in accordance with the invention. Memory leakage, broadly defined, is the gradual loss of allocable memory due to the failure to de-allocate previously allocated, but no longer utilized memory. Typically, memory can be reserved for data having a brief usable lifecycle period. Once the lifecycle is complete, the reserved memory should be returned to the pool of allocable memory so that it can be subsequently used by other processes. If memory leakage persists unaddressed, eventually insufficient available memory will remain to accommodate other processes. Memory leakage is difficult to detect and track and is therefore often simply tolerated. For short-term programs, permitted a certain level of memory leakage is not serious. However, in long-running programs having very high reliability requirements, memory leakage can be a major problem and is less tolerable.

FIG. 1 illustrates a network environment applicable to the present invention in which multiple requesters or client nodes 102a-102n and a server cluster 105 are connected to a network 110. Requesters such as client nodes 102a-102n send service requests to server cluster 105 via the network 110. Examples of the network types that may be embodied by network 110 include, but are not limited to, wide-area networks (WANs) such as the Internet, and local area networks (LANs). As shown in FIG. 1, server cluster 105 includes multiple server nodes 104a-104n to handle high traffic demand and may be a proxy server cluster, Web server cluster, or other type. Servers 104a-104n within server cluster 105 may include, but are not limited to, products such as are sold by IBM under the trademarks S/390 SYSPLEX, SP2, or RS6000 systems. In accordance with well-known client-server architecture principles, requests from clients 102a-102n may be handled by any of servers 104a-104n within server cluster 105. Typical of such client requests may be service requests including World-Wide-Web page accesses, remote file transfers, electronic mail, and transaction support.

One of the advantages of a clustered system such as that shown in FIG. 1 is that it has hardware and software redundancy, because the cluster system consists of a number of independent nodes, and each node runs a copy of operating system and application software. High availability can be achieved by detecting node or daemon failures and reconfiguring the system appropriately, so that the workload can be taken over by the remaining nodes in the cluster.

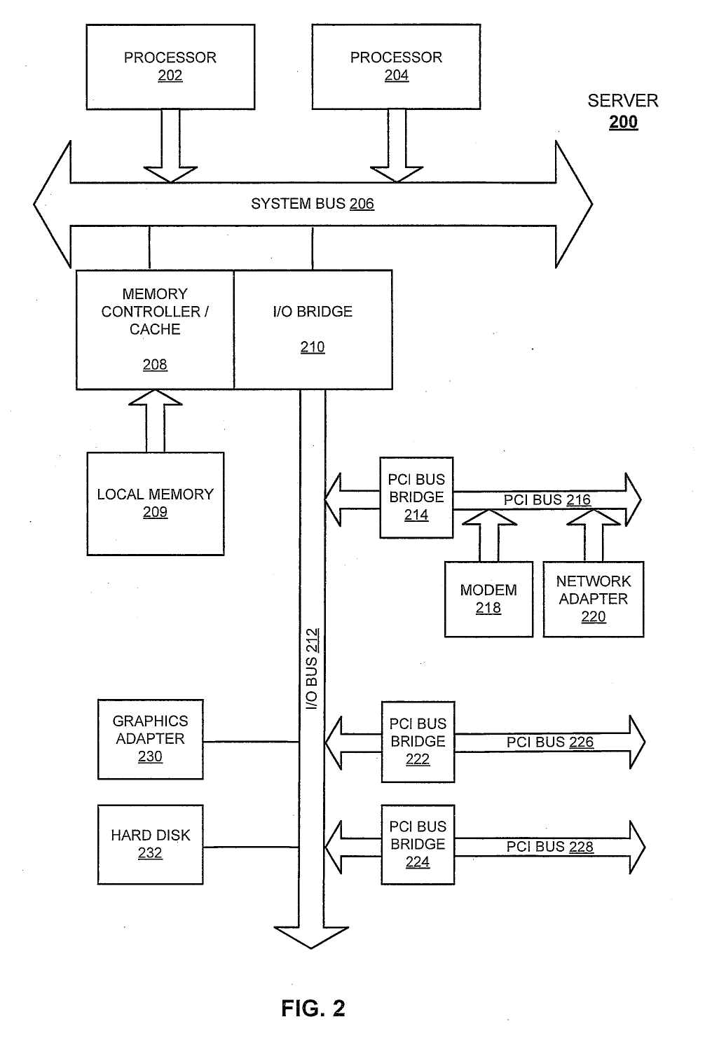

Referring to FIG. 2, there is illustrated a block diagram of a server system 200 that may be implemented as one or more of server nodes 104a-104n in FIG. 1, in accordance with the invention. Server system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

A peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to client nodes 102a-102n in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX operating system.

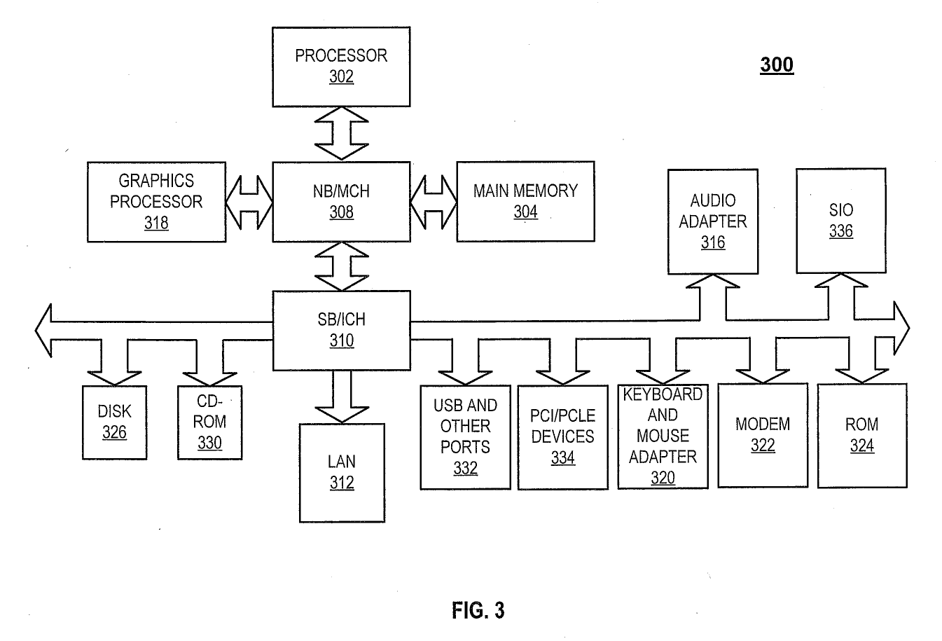

With reference now to FIG. 3, a block diagram of a data processing system is shown in which features of the present invention may be implemented. Data processing system 300 is an example of a computer, such as one of server nodes 104a-104n and/or one or more of client node 102a-102n in FIG. 1, in which code or instructions implementing the processes of the present invention may be stored and executed. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, LAN adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash basic input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300. The operating system may be a commercially available operating system such as AIX®. An object oriented programming system, such as the Java® programming system, may run in conjunction with the operating system and provides calls to the operating system from Java® programs or applications executing on data processing system 300.

Instructions for the operating system, the object-oriented programming system, and applications or programs are located on storage devices, such as hard disk drive 326, and may be loaded into main memory 304 for execution by processor 302. The processes of the present invention may be performed by processor 302 using computer implemented instructions, which may be stored and loaded from a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system such as that described with reference to FIG. 2.

Data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

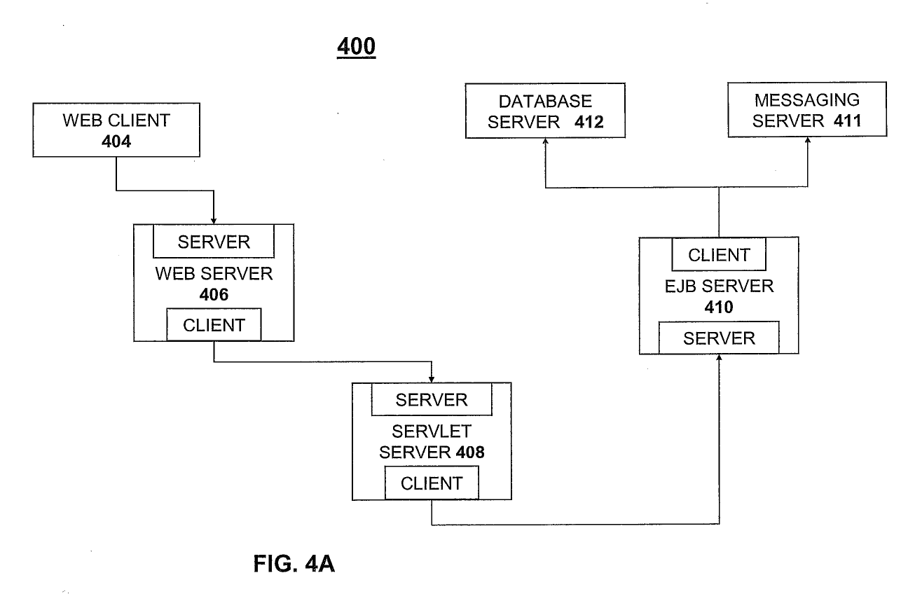

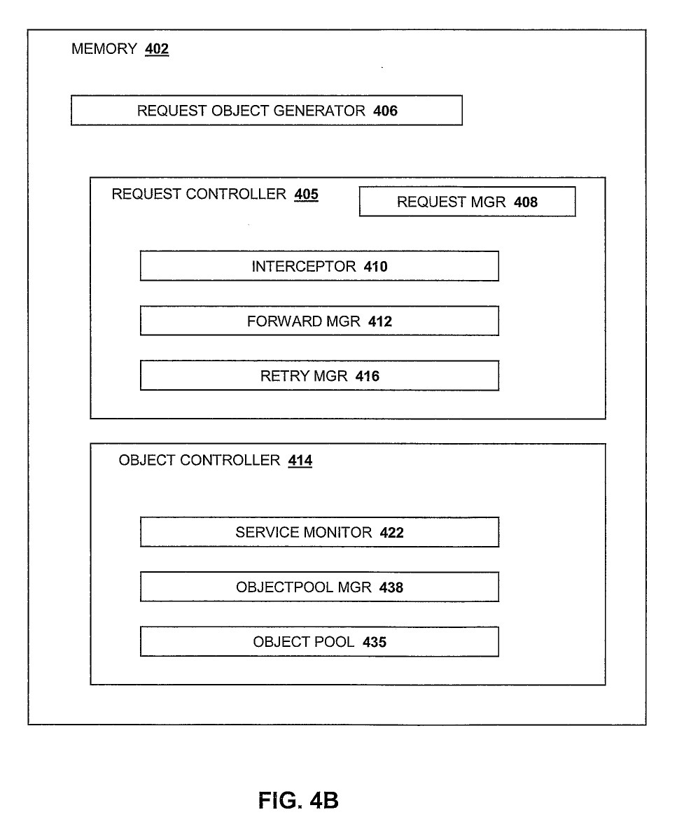

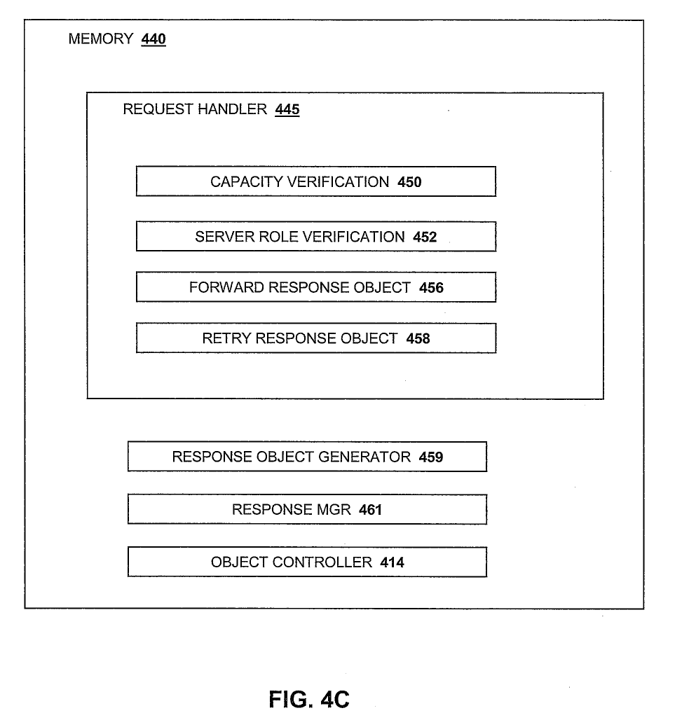

FIG. 4A is a high-level block diagram representation of a client/server request handling chain 400 that handles requests in a high availability system in accordance with the invention. The depicted request handling chain comprises a multi-tiered architecture in which client and server functionality are co-located in common nodes and are in fact relative to the immediate function within the chain. For example, a web browser 404 functions as a client with respect to server functionality within a web server 406. Likewise, web server 406 functions as a client with respect to the server side of a servlet server (web container) 408, which in turn functions as a client with respect to an Enterprise Java Bean (EJB) container 410. The illustrated multi-tier client/server request handling chain terminates with EJB container 410 interfacing as a client with respect to a database server 412 and message server 411.

The client-side functionality within each of the nodes within request handling chain 400 may be represented such as by requester clients 102 depicted in FIG. 1 which generate and issue client requests to servers within server cluster 105. Similarly, the server-side functionality within each of the nodes within request handling chain 400 may be represented such as by the servers 104 within server cluster 105.

Referring to FIG. 4B, there is depicted a high-level block diagram representation of client-side request handling components in accordance with the present invention. Several processing modules including a request object generator 406, a request controller 405, and an object controller 414 are loaded into a memory device 402. Each of the program processing modules depicted in FIG. 4B as well as other figures herein are preferably embodied as computer-executable code that may be loaded into memory 402 for execution by hardware and firmware processing means such as those included in a CPU. The client-side program module loaded into memory 402 may be downloaded from local non-volatile data storage or from a network source.

In accordance with the depicted embodiment, request object generator 406 generates client request objects corresponding to client requests to be sent to servers such as those depicted in FIG. 4A. Further detail regarding request object generation such as by using fuzzy logic matching is provided below. Servers receiving client requests generated by request object generator may include dedicated server nodes such as database and message servers 412 and 411 and may also include server functionality incorporated into servers such as web server 406, servlet container 408 and EJB server 410 which contain client functions integrated within server functionality.

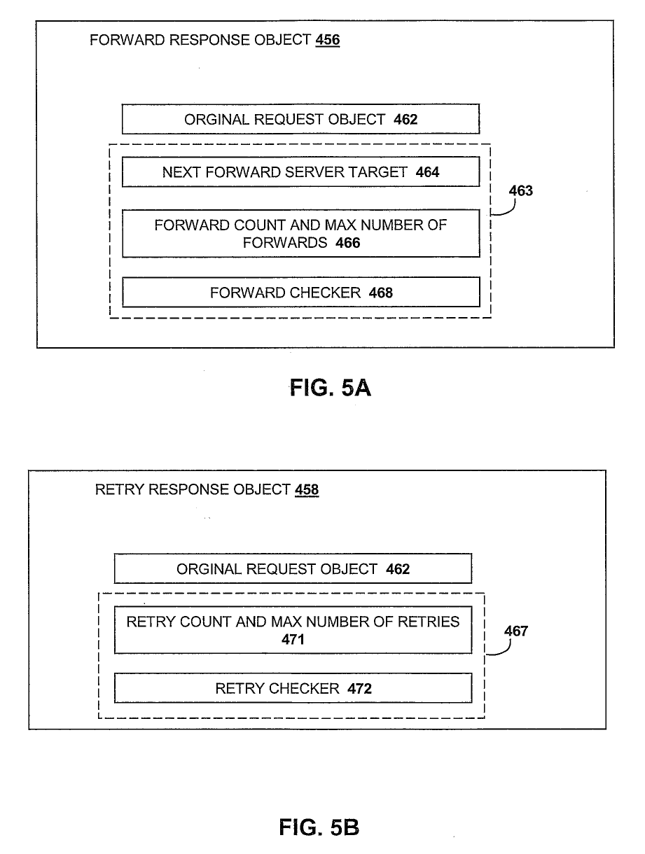

As further shown in FIG. 4B, request controller 405 generally comprises an interceptor 410, a forward manager 412, a retry manager 416, and a request manager 408. Interceptor 410 intercepts requests/response objects traversing a client/server chain such as request handling chain 400. In particular, interceptor 410 intercepts retry response and forward response objects, such as those depicted and described below with reference to FIGS. 4C, 5A, and 5B, which include encoded indicia indicating whether a given request has been successfully responded to or is still pending.

Forward manager 412 includes program and logic modules and instructions for tracking and managing the number of hops a given request has or may be forwarded over. For example, forward manager 412 may determine whether to forward a request in view of a maximum limit that may be imposed on how many hops may be attempted.

Retry manager 416 manages retry exception conditions by determining whether to execute a retry attempt (i.e. repeat request to the same server). The retry determination preferably accounts for and imposes a pre-specified maximum limit on the number of retries for a given request. The difference between a forward and a retry is that a forwarded request is sent to different server while a retried request is sent to the same server at later time.

Request controller 405 further includes a request manager 408 that manages request lifecycle to ensure that only one response is delivered for each request. As part of its request management responsibilities, request manager 408 also implements a memory garbage collection policy in which objects for non-pending requests (i.e. requests that have been successfully or unsuccessfully terminated) are removed or marked for reuse.

In addition to the request-centric modules contained in request controller 405, request controller further comprises features within object controller 414 for generating requests/responses and managing exception condition objects associated with individual requests/responses. In general, service monitor daemons (represented as part of service monitor module 422) run on object controller 414 to periodically check server processing conditions. If there is no response for service access request from a server in a specified time, service monitor 422 determines the server as having failed and removes it from the available server list (not depicted) maintained by object controller 414. The failed server may subsequently be added back to the server list after it has been determined to be reliable. In this manner, object controller 414 can mask the failure of service daemons or servers. Furthermore, administrators can also use system tools to add new servers to increase the system throughput or remove servers for system maintenance, without bringing down the whole system service.

In addition to its role in balancing client request dispatching among virtualized computing resources, object controller 414 further includes an object pool 435 and supporting object management logic within an object pool manager 438 for managing service request exception conditions that may arise incident to processing client requests. Request/response objects are maintained in object pool 435 and selected during request/response generation.

The primary function of object controller 414 is to retrieve re-usable request objects using fuzzy logic matching and to clean (remove or mark as dirty) objects associated with a non-pending request to facilitate efficient re-allocation of the memory. Object pool manager 435 includes logic and program means for tracking and maintaining a specified maximum memory utilization by removing or marking less frequently utilized objects. In one embodiment, object pool manager 438 enforces the maximum memory utilization limit by implementing a Least Recently Used (LRU) memory replacement policy.

FIG. 4C is a high-level block diagram representation of server-side request handling components in accordance with the present invention. With reference to the server-side modules depicted in FIG. 4C, it should be noted that any server may contain both client and server features such that the server can handle requests locally or send presently non-serviceable requests to other servers (act as client) for further handling. Therefore, both server-side and client-side memory utilization must be managed to ultimately manage server memory.

As illustrated in FIG. 4C, several request and object handling modules are loaded into a server side memory 440. As with the client side depicted in FIG. 4B, the server side request management features include object controller 414 which includes the object pool and management features shown in FIG. 4B. Server-side request handling modules further include a request handler 445, a response object generator 459, and a response manager 461.

As further depicted in FIG. 4C, request handler 445 comprises a capacity verification module 450, a server role verification module 452, as well as one or more forward response objects 456 and retry response objects 458. As explained in further detail below, forward response object 456 and retry response object 458 enable individualized, remotely accessible processing and tracking of request/response objects such that the objects are not locally cached within a particular server or client node in case of a retry or forward exception condition.

Capacity verification module 450 performs realtime tracking of processing and memory resource utilization to determine whether the server has present capacity to handle a given request. Responsive to determining the server has insufficient present processing capacity to handle a request, capacity verification module 450 further determines whether or not the request should be retried at later time (i.e. whether or not to generate a RetryException) or forwarded (ForwardException).

Server role verification module 452 includes program logic means for determining whether the server is correctly configured or is otherwise able to process and successfully respond to the request. Responsive to server role verification module 452 determining that the server is not properly configured or otherwise functionally able to successfully process the substance of a request, a ForwardException object is generated and utilized to forward the request to another server that is functionally capable of processing the request. For example, if an update data request is sent to a replica server having read-only request processing capability, the replica server forwards the request to a master data server having the requisite write processing capability.

Forward response object 456 and retry response object 458 are data structures that may be generated by response manager 461 or object controller 414 responsive to the retry exception conditions or forward exception conditions detected in association with a given request as explained above by capacity verification module 450 and/or server role verification module 452. Referring now to FIGS. 5A and 5B, more detailed block diagram representations of forward response object 456 and retry response object 458 are illustrated. Forward response object 456 and retry response object 458 are utilized to coordinate client and server-side request handling to ensure only a single response per request and clean up or mark for re-use objects associated with non-pending requests. The data fields in forward response object 456 and retry response object 458 further include specified data items required to complete request handling regardless of the number of times the request is retried or how many hops the request is forwarded over.

Both forward response object 456 and retry response object 458 contain the original request object 462 that enables the client and server sides to mark the object for re-use immediately upon termination or successful response to the request. Tracking request object 462 within the exception objects themselves also helps avoid the memory leak that would otherwise occur when a request processing “hangs” (never finishes) such as by a failure in the request handling mechanism. The primary difference between ForwardException object 456 and RetryException object 458 lies in the different exception objects, namely, in a ForwardException object 463 included within forward response object 456 and a RetryException object 467 within retry response object 458. ForwardException object 463 is generated by the server in response to detecting that in accordance with either capacity verification module 450 or server role verification module 452 that a forward exception is the correct response to a detected request processing failure. ForwardException object 463 includes forwarding mechanisms such as next forward module 464, forward count and max forward limit module 466 and forward checker 468 that specify conditions for sending the request to other servers.

RetryException object 467 is generated by the server in response to detecting that in accordance with capacity verification module 450 or otherwise that a retry exception is the correct response to a detected request processing failure. RetryException object 467 includes a retry checker 472 that indicates that the request will be sent to the same server again at later time. ForwardException object 456 includes next server target object 464 that specifies the target server that the request will be forwarded to. Forward count and max forward field 466 specifies the cumulative number of forward hops for the request and also the maximum permissible number of hops for the request.

To generate responses, object controller 414 uses fuzzy logic to look up and retrieve a closest matching pre-stored object within the object pool. Object controller 414 in conjunction with response object generator 459 and response manager 461 modify the matched and retrieved pre-stored object in accordance with the required response. If a forward response is required, a ForwardException object is inserted into the response object. If a retry response is required, a RetryException object is inserted into the response object. Response manager 461 specifies the event-based or temporal-based duration of a response cycle to ensure objects within the object pool associated with a given request handling cycle are cleaned or marked for re-use upon successful or unsuccessful termination of the request handling cycle.

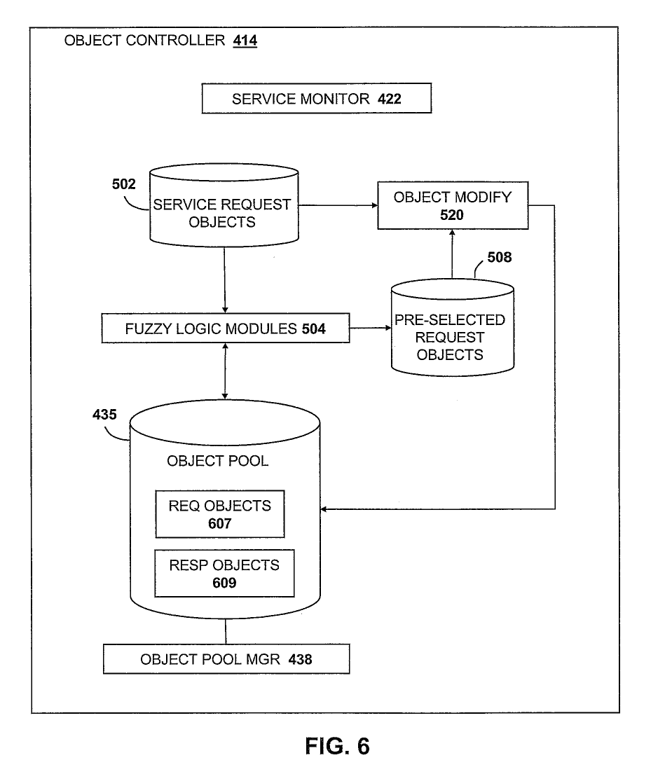

Referring to FIG. 6, there is depicted a high-level block diagram illustrating object controller 414 managing object pool 435. As shown in FIG. 6, object controller 414 generally comprises several functional units illustrated in discrete block representative manner for illustrative purposes only. In conjunction, the functional units include means for processing client service request object data utilizing fuzzy logic to identify a closest matching pre-stored object pool object. In this manner, object manager and object pool resources are provided with a best assessment of client request objects without having to expend the considerably processing and storage resources that would be required for exact key matching.

Object controller 414 further comprises a set of one or more fuzzy logic modules 504 that are utilized to process the pre-specified request objects 607 and response objects 609 within object pool 535 in association with received service request/response objects 502. Specifically, fuzzy logic module 504 comprises one or more modules that perform fuzzy logic clustering among the stored request objects within object pool 435 to correlate each of request objects 502 with a closest match among the stored objects within object pool 435. Fuzzy logic module 504 processes request objects 502 in association with the pre-stored objects within object pool 435 using fuzzy logic clustering algorithms such as fuzzy subtractive clustering and/or fuzzy c-means clustering. The clustering correlation performed by fuzzy logic modules 504 results in request objects from object pool 435 being selected (block 508) and input to an object modify module 520. Object modify module 520 including program and logic means for modifying pre-selected request objects 508 in-fight in accordance with the corresponding original client request objects 502.

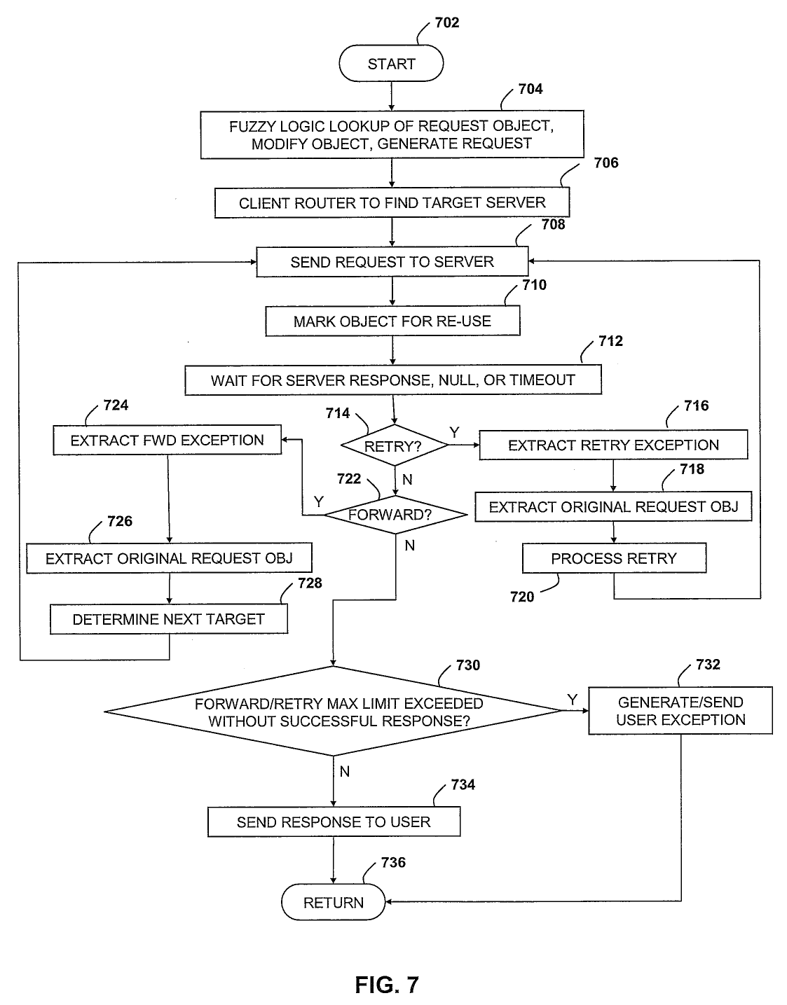

With reference now to FIG. 7, there is illustrated a high-level flow diagram depicting steps performed during client-side service request management in accordance with one embodiment of the present invention. The process begins as shown at steps 702 and 704 with the fuzzy logic module being utilized to lookup and retrieve a pre-stored object from among objects persistently stored in the object pool that most closely matches a current client request. Next, the target server is identified using standard client-side routing as illustrated at step 706. The request is send to the server and corresponding request handling objects stored in the client marked for re-use (steps 708 and 710).

The client waits for a server response that may be embodied as a successful substantive response, a null response or a failure triggered by a specified request handling timeout period (step 712). In response to a retry response object received from the server, a RetryException object is extracted from the response together with the original request object. The RetryException object is processed by resending the request object to the same server (steps 714, 716, 718, 720 and 708). In response to a forward response object received from the server, a ForwardException object is extracted together with the original request object and the resultant ForwardException is processed by forwarding the request to a different server (steps 722, 724, 726, 728 and 708).

As shown at steps 730 and 732, in response to the client failing to receive a successful response to the request after to a cumulatively tracked number of forward or retry attempts exceeding a pre-specified maximum limit, a user exception is generated and sent to notify the user that the request has failed and the process returns as shown at step 736. If the client receives a successful response within the pre-specified limits on forward and/or retry attempts, the client generates and sends the response to the user and the process ends (steps 730, 734, and 736).

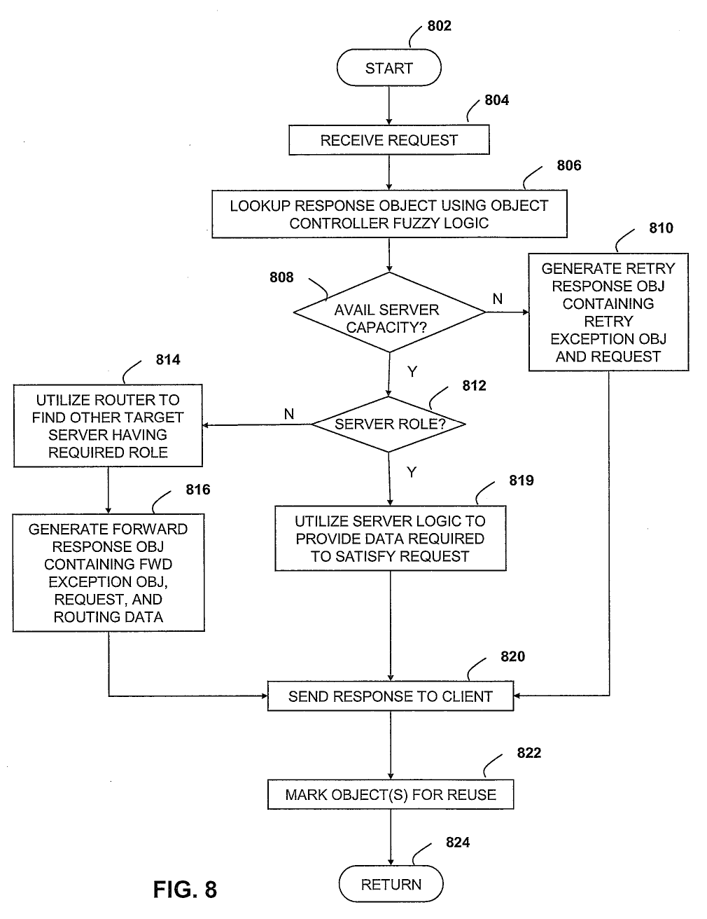

FIG. 8 is a high-level flow diagram depicting steps performed during server-side service request management in accordance with one embodiment of the present invention. The process begins as shown at steps 802 and 804 with the server receiving a request. The fuzzy logic module is utilized to lookup a closest matching pre-stored object as depicted at step 806. Next, in response to insufficient server processing capacity, a RetryException object is generated and incorporated into a retry response object which also includes the original request (steps 808 and 810). The retry response is sent to the client to be processed as described above. The objects associated with the request are marked for reuse and the process returns (steps 820, 822, and 824).

Assuming sufficient processing capacity, the server-side request handler further determines whether the server is configured for or otherwise is functionally capably of substantively handling the request. If the server is not configured to handle the request, routing devices are utilized to find a target server having the requisite request handling capability (steps 812 and 814). The server then generates a forward response object containing a ForwardException object, the client request, and routing information identifying server(s) traversed by the request (step 816). The forward response object is sent to the client which processes the forward response as described above. If adequate server processing resources are available and the server is properly configured to substantively satisfy the request, server logic is utilized to satisfy the request (step 819) which is sent as a successful response to the client (step 820). As with the retry and forward processing cases, the server responds to sending the successful response by marking associated objects for re-use (step 822) and the process returns (step 824).

Applying the above depicted and described mechanisms and techniques, it has been demonstrated that a high-traffic server can run steadily several months without any significant memory leakage regardless of the numbers of hard and soft failovers that occur.

The disclosed methods may be readily implemented in software using object or object-oriented software development environments that provide portable source code that can be used on a variety of computer or workstation hardware platforms. In this instance, the methods and systems of the invention can be implemented as a routine embedded on a personal computer such as a Java or CGI script, as a resource residing on a server or graphics workstation, as a routine embedded in a dedicated source code editor management system, or the like.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A method for managing service request exception conditions in a computer system that services client requests, said method comprising:
receiving a client request; and
responsive to an exception condition occurring incident to processing the client request, generating an exception response object containing the client request and an exception object identifying the exception condition.

2. The method of claim 1, wherein the client request is generated using a request object matching sequence comprising:
selecting a request object from an object pool by correlating the client request with multiple pre-stored request objects; and
modifying the selected request object to match the original client request.

3. The method of claim 2, said selecting a request object further comprising utilizing a fuzzy logic function to correlate the original client request with multiple pre-stored request objects.

4. The method of claim 1, wherein said exception condition is a retry condition, said generating an exception response object further comprising, responsive to the retry exception condition, generating a retry response object containing the selected request object.

5. The method of claim 1, wherein said exception condition is a forward condition, said generating an exception response object comprising, responsive to the forward exception condition, generating a forward response object containing the selected request object and further containing routing information for the client request.

6. The method of claim 5, wherein the routing information contained within the forward exception object includes server identification information.

7. The method of claim 1, further comprising implementing a least recently used replacement policy to replace objects within the object pool.

8. A system for managing service request exception conditions in a computer system that services client requests, said system comprising:
means for receiving a client request; and
means responsive to an exception condition occurring incident to processing the client request, for generating an exception response object containing the client request and an exception object identifying the exception condition.

9. The system of claim 8, wherein the client request is generated using a request object matching sequence means comprising:
means for selecting a request object from an object pool by correlating the client request with multiple pre-stored request objects; and
means for modifying the selected request object to match the original client request.

10. The system of claim 9, said means for selecting a request object further comprising means for utilizing a fuzzy logic function to correlate the original client request with multiple pre-stored request objects.

11. The system of claim 8, wherein said exception condition is a retry condition, said means for generating an exception response object further comprising, means responsive to the retry exception condition, for generating a retry response object containing the selected request object.

12. The system of claim 8, wherein said exception condition is a forward condition, said means for generating an exception response object comprising, means responsive to the forward exception condition, for generating a forward response object containing the selected request object and further containing routing information for the client request.

13. The system of claim 5, wherein the routing information contained within the forward exception object includes server identification information.

14. A data storage device having encoded thereon computer-executable instructions for managing service request exception conditions in a computer system that services client requests, said computer-executable instruction performing a method comprising:
receiving a client request; and
responsive to an exception condition occurring incident to processing the client request, generating an exception response object containing the client request and an exception object identifying the exception condition.

15. The data storage device of claim 14, wherein the client request is generated using a request object matching sequence comprising:
selecting a request object from an object pool by correlating the client request with multiple pre-stored request objects; and
modifying the selected request object to match the original client request.

16. The data storage device of claim 13, said selecting a request object further comprising utilizing a fuzzy logic function to correlate the original client request with multiple pre-stored request objects.

17. The data storage device of claim 14, wherein said exception condition is a retry condition, said generating an exception response object further comprising, responsive to the retry exception condition, generating a retry response object containing the selected request object.

18. The data storage device of claim 14, wherein said exception condition is a forward condition, said generating an exception response object comprising, responsive to the forward exception condition, generating a forward response object containing the selected request object and further containing routing information for the client request.

19. The data storage device of claim 18, wherein the routing information contained within the forward exception object includes server identification information.

20. The data storage device of claim 14, further comprising implementing a least recently used replacement policy to replace objects within the object pool.
